(19) United States
(12) Patent Application Publication
(10) Pub. No.: US 2024/0203116 A1
(43) Pub. Date: Jun. 20, 2024

(54) INFORMATION PROCESSING DEVICE AND INFORMATION PROCESSING SYSTEM

(71) Applicant: TOYOTA JIDOSHA KABUSHIKI KAISHA, Toyota-shi (JP)

(72) Inventors: Osami HASHIMOTO, Mishima-shi (JP); Hiroki TASHIMA, Fujisawa-shi (JP); Toshihiko INOUE, Nagoya-shi (JP); Kazuma TOYA, Anjo-shi (JP); Takashi TAZOE, Nagoya-shi (JP); Ryota BINGO, Nisshin-shi (JP); Kosuke SAKAKIBARA, Toyota-shi (JP)

(73) Assignee: TOYOTA JIDOSHA KABUSHIKI KAISHA, Toyota-shi (JP)

(21) Appl. No.: 18/489,349

(22) Filed: Oct. 18, 2023

(30) Foreign Application Priority Data
Dec. 15, 2022 (JP) 2022-200596

(51) Int. Cl. G06V 20/13; B60W 30/14; G06V 10/74; G06V 20/50

(52) U.S. Cl. CPC G06V 20/13; B60W 30/146; G06V 10/761; G06V 20/50; B60W 2420/42; B60W 2552/00; B60W 2556/60

(57) ABSTRACT

An information processing device acquires, for a predetermined point, a first satellite image captured by the artificial satellite and a second satellite image captured at the same point a predetermined time after the first satellite image was captured, compares the first satellite image and the second satellite image to identify any change in state therebetween, determines whether the change is a portion where the state has changed due to traveling of the vehicle, and sets the change as a dangerous point when the change is due to traveling of the vehicle.

### CROSS-REFERENCE TO RELATED APPLICATION

This application claims priority to Japanese Patent Application No. 2022-200596 filed on Dec. 15, 2022, incorporated herein by reference in its entirety.

### BACKGROUND

### 1. Technical Field

The present disclosure relates to information processing devices and information processing systems.

### 2. Description of Related Art

Japanese Unexamined Patent Application Publication No. 2008-191988 (JP 2008-191988 A) discloses a vehicle surroundings monitoring device that creates a bird's-eye view image of the surroundings of a vehicle based on images including other vehicles traveling around the vehicle as captured on a road by a plurality of cameras installed on the road on which the vehicle is traveling.

### SUMMARY

However, the device described in JP 2008-191988 A cannot create a bird's-eye view image at a place where no camera is installed on the road, and cannot grasp dangerous spots on the traveling road in a wide range of area.

It is an object of the present disclosure to provide an information processing device and an information processing system that can grasp dangerous spots on a traveling road in a wide range of area.

An information processing device according to a first aspect of the present disclosure is configured to acquire a first satellite image captured at a predetermined point by an artificial satellite and a second satellite image captured at the point a predetermined time after the first satellite image is captured, compare the first satellite image and the second satellite image to identify any change in state between the first satellite image and the second satellite image, determine whether the change is a portion where the state has changed due to traveling of a vehicle, and when the change is the portion where the state has changed due to traveling of the vehicle, set the change as a dangerous point.

The information processing device according to the first aspect acquires the second satellite image captured at the same point as the first satellite image the predetermined time after the first satellite image is captured. The information processing device compares the first satellite image and the second satellite image to identify any change in state between the first satellite image and the second satellite image. Since the satellite images are thus compared to identify any change therebetween, changes can be identified in a wide range of area without installing cameras on a road etc.

The information processing device determines whether the change is a portion where the state has changed due to traveling of the vehicle, and when the change is the portion where the state has changed due to traveling of the vehicle, sets the change as a dangerous point. Accordingly, dangerous points can be identified even in an area where the infrastructure is not developed enough and an area where only a small number of vehicles are traveling.

The information processing device according to the first aspect may be configured to, when the change is a portion including a brake mark, determine that the change is the portion where the state has changed due to traveling of the vehicle.

The above information processing device identifies the portion with a brake mark from sudden braking of the vehicle etc. as a change. The portion with a brake mark can thus be set as a dangerous point.

The information processing device according to the first aspect may be configured to, when a plurality of the dangerous points is detected within a predetermined section, set the section as a dangerous section.

The above information processing device can alert an occupant of the vehicle etc. by setting the section where a plurality of dangerous points is detected as a dangerous section.

In the information processing device according to the first aspect, the change may include a portion where an accessory of a road is damaged.

The above information processing device can set the portion where an accessory of a road is damaged due to traveling of the vehicle as a dangerous point. The term “accessory” as used herein includes a wide range of things such as fences on roads, road signs, road lighting equipment, and street trees.

An information processing system according to a second aspect of the present disclosure includes: the information processing device according to the first aspect; and a vehicle control device configured to control the vehicle.

The vehicle control device is configured to set an upper limit of a vehicle speed for a vehicle traveling near the change set as the dangerous point by the information processing device.

The information processing system according to the second aspect can reduce the risk of an accident etc. at the dangerous point by setting the upper limit speed for the vehicle that is going to travel through the change set as the dangerous point.

As described above, according to the information processing device and the information processing system of the present disclosure, it is possible to grasp dangerous spots on a traveling road in a wide range of area.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram schematically illustrating an entire information processing system according to an embodiment;

FIG. 2 is a block diagram illustrating a hardware configuration of the information processing device according to the embodiment;

FIG. 3 is a block diagram illustrating a hardware configuration of the in-vehicle device according to the embodiment;

FIG. 4 is a block diagram illustrating a functional configuration of the information processing device according to the embodiment;

FIG. 5 is a flow chart illustrating an exemplary flow of information processing in the embodiment; and

FIG. 6 is a flowchart illustrating another example of the flow of information processing according to the embodiment.

### DETAILED DESCRIPTION OF EMBODIMENTS

An information processing system S including the information processing device 10 according to the embodiment will be described with reference to the drawings.

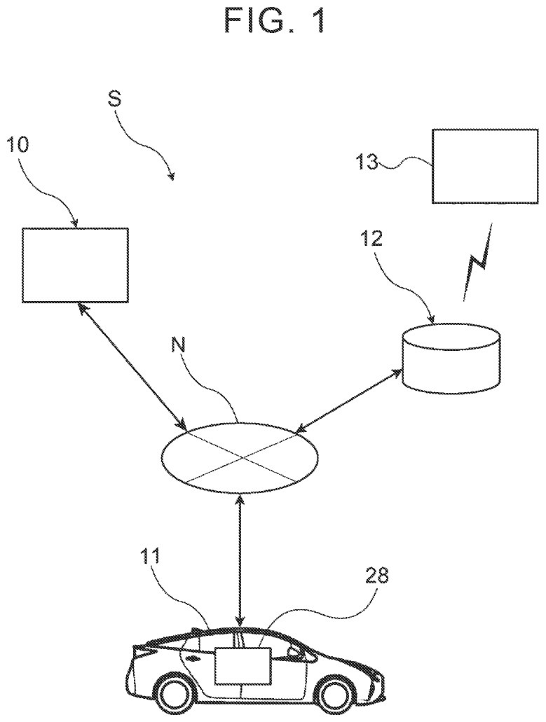

As illustrated in FIG. 1, the information processing system S according to the present embodiment includes an information processing device 10, a server 12, and a vehicle 11. The information processing device 10, the server 12, and the vehicle 11 are connected to each other via a network N and can communicate with each other.

The information processing device 10 is installed outside the vehicle 11, for example, and is configured to transmit the requested information in response to an instruction from the vehicle 11. Further, the information processing device 10 is configured to be able to acquire various kinds of information from the server 12 via the network N. The information processing device 10 may be connected to the plurality of vehicles 11 via a network N.

The vehicle 11 includes an in-vehicle device 28 as a vehicle control device. The in-vehicle device 28 of the present embodiment is, for example, an electronic control unit (ECU) that performs various controls. The server 12 is installed outside the vehicle 11 and is configured to be capable of receiving data from the artificial satellite 13. Therefore, the server 12 stores satellite images captured by the artificial satellites. In addition, information such as map information, dangerous points, and dangerous sections is stored in the server 12, and necessary information is transmitted to the in-vehicle device 28 via the network N in response to a request from the in-vehicle device 28 (vehicle 11).

The information processing system S of the present embodiment is configured as described above, and the information processing device 10 acquires the first satellite image and the second satellite image captured before and after the lapse of the predetermined time at the same point, compares the first satellite image and the second satellite image, and identify any change in state therebetween. Further, it is determined whether the change is a portion where the state has changed due to the traveling of the vehicle, and when the change is caused by the traveling of the vehicle, the change is set as a dangerous point.

### Hardware Configuration of Information Processing Device 10

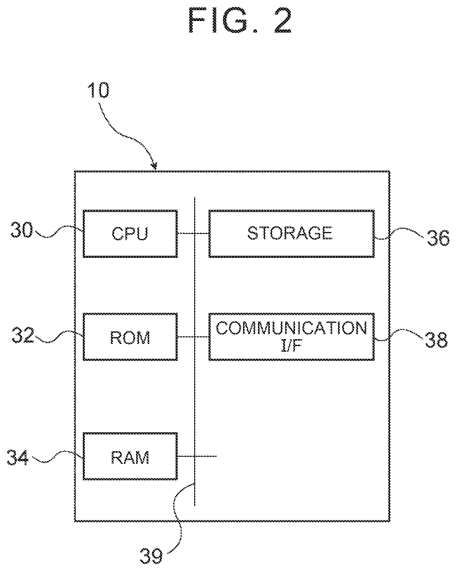

As illustrated in FIG. 2, the information processing device 10 includes a central processing unit (CPU, processor) 30, a read-only memory (ROM) 32, a random access memory (RAM) 34, a storage 36, and a communication interface (communication I/F) 38. These configurations are communicably connected to each other via an internal bus 39.

CPU 30 is a central processing unit that executes various programs and controls each unit. That is, CPU 30 reads the program from ROM 32 or the storage 36, and executes the program using RAM 34 as a working area. In addition, CPU 30 performs control of the above-described configurations and various arithmetic processes in accordance with programs recorded in ROM 32 or the storage 36.

ROM 32 stores various programs and various data. RAM 34 temporarily stores a program or data as a working area. The storage 36 is a non-transitory recording medium that is composed of a hard disk drive (HDD) or a solid state drive (SSD) and stores various programs including an operating system and various types of data. In the present embodiment, the ROM 32 or the storage 36 stores programs and the like for performing various processes.

The communication I/F 38 is an interface for the information processing device 10 to communicate with the server 12, the in-vehicle device 28, and other devices, and standards such as a controller area network (CAN), Ethernet (registered trademark), long term evolution (LTE), fiber distributed data interface (FDDI), and Wi-Fi (registered trademark) are used.

### Hardware Configuration of In-Vehicle Device 28

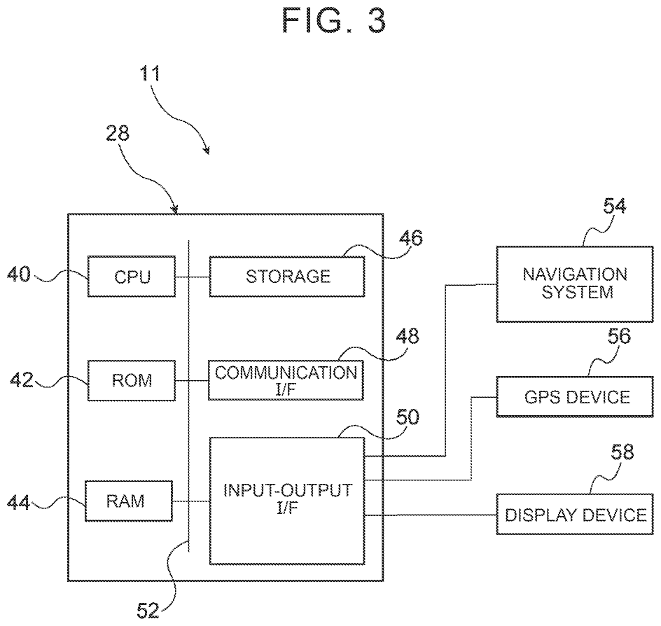

As illustrated in FIG. 3, the in-vehicle device 28 includes a CPU 40, a ROM 42, a RAM 44, a storage 46, and a communication interface (communication I/F) 48 and an input-output interface (input-output I/F) 50. These configurations are communicably connected to each other via an internal bus 52.

The CPU 40 is a central processing unit that executes various programs and controls each unit. That is, the CPU 40 reads the program from the ROM 42 or the storage 46, and executes the program using the RAM 44 as a working area. In addition, the CPU 40 performs control of the above-described configurations and various arithmetic processes in accordance with programs recorded in the ROM 42 or the storage 46.

The ROM 42 stores various programs and various data. The RAM 44 temporarily stores a program/data as a working area. The storage 46 is a non-transitory recording medium that is composed of a HDD or a SSD and stores various programs including an operating system and various data.

The communication I/F 48 is a face for the in-vehicle device 28 to communicate with servers and other devices, and standards such as a controller area network (CAN), Ethernet (registered trademark), long term evolution (LTE), fiber distributed data interface (FDDI), and Wi-Fi (registered trademark) are used.

A navigation system 54, a global positioning system (GPS) device 56, and a display device 58 are connected to the input-output I/F 50. The navigation system 54 sets a travel route from the current location of the vehicle 11 to the destination, and performs various guidance so that the vehicle 11 can travel along the travel route. At this time, the navigation system 54 appropriately acquires the map information from the server 12. In addition, in a case where some or all of the map information is stored in the storage 46, the travel route may be set without acquiring the map information from the server 12.

GPS device 56 is a device that receives GPS signals from GPS satellites to determine the current location of the vehicle 11. The display device 58 displays various kinds of information on a display unit (not shown) provided in the vehicle cabin. For example, the display device 58 displays information on the travel route set by the navigation system 54, information on the dangerous point and the dangerous section, and the like on the display unit.

### Functional Configurations of Information Processing Device 10

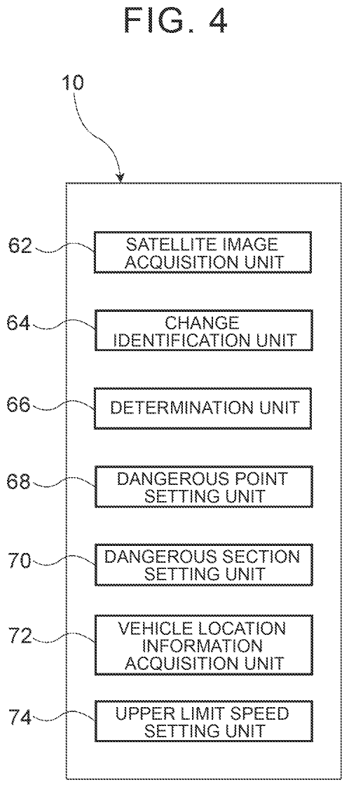

The information processing device 10 implements various functions using the above-described hardware resources. A functional configuration realized by the information processing device 10 will be described with reference to FIG. 4.

As illustrated in FIG. 4, the information processing device 10 includes, as functional configurations, a satellite image acquisition unit 62, a change identification unit 64, a determination unit 66, a dangerous point setting unit 68, a dangerous section setting unit 70, a vehicle position information acquisition unit 72, and an upper limit speed setting unit 74. These functional configurations are implemented by the CPU 30 reading and executing programs stored in the ROM 32 or the storage 36.

The satellite image acquisition unit 62 acquires, for a predetermined point, a first satellite image captured by the artificial satellite 13 and a second satellite image captured at the same point a predetermined time after the first satellite image was captured. For example, the satellite image captured by the artificial satellite 13 is stored in the server 12 for each capturing point, and the artificial satellite 13 captures the same capturing point at a predetermined cycle. At this time, the captured satellite images are sequentially stored in the server 12 for each shooting point.

If the artificial satellite 13 is a geostationary satellite, the same photographing point can be photographed at an arbitrary timing, and therefore, for example, the photographing point may be photographed every several hours and the satellite image may be stored in the server 12. If the artificial satellite 13 is an earth low-orbit satellite, the shooting frequency is based on the number of regression days, so the same shooting point is taken at the timing calculated based on the number of artificial satellites 13 and the number of regression days. For example, if two artificial satellites 13 each have four days of regression, a satellite image obtained by photographing a photographing point every 48 hours is stored in the server 12.

The satellite image acquisition unit 62 accesses the server 12, and acquires the first satellite image and the second satellite image captured a predetermined time after the first satellite image was captured, from the satellite images at the same shooting point stored in the server 12. Note that the timing and the shooting point at which the satellite image acquisition unit 62 acquires the satellite image are not particularly limited. For example, the satellite image acquisition unit 62 may acquire a satellite image at a point corresponding to the travel route at a timing when the travel route is set by the occupant of the vehicle 11.

The change identification unit 64 compares the first satellite image and the second satellite image to identify any change in state therebetween. For example, the change identification unit 64 excludes moving objects such as vehicles or people from the first satellite image and the second satellite image, and identifies a change regarding a road or accessories. The change may be identified using a deep learning model in addition to a method such as an image difference method. As a method using the deep learning model, there is a method such as a fully convolutional network (FCN).

The determination unit 66 determines whether the change identified by the change identification unit 64 is a portion where the state has changed due to traveling of the vehicle. For example, when the change is a portion including a brake mark, the determination unit 66 determines that the change is a portion where the state has changed due to the traveling of the vehicle. When the change includes a portion where an accessory of the road is damaged, the determination unit 66 may determine that the change is a portion where the state has changed due to traveling of the vehicle. On the other hand, when the change is caused by a falling object, the determination unit 66 may determine that the change is not a portion where the state has changed due to traveling of the vehicle.

When the change is caused by traveling of the vehicle, the dangerous point setting unit 68 sets the change as a dangerous point. That is, the dangerous point setting unit 68 is set to be a dangerous point with respect to a point where the determination unit 66 determines that the point is a place where the state has changed due to the traveling of the vehicle. The dangerous point setting unit 68 may store information on the dangerous point in the server 12. For example, the dangerous point setting unit 68 may store, in the server 12, coordinate information of the point set as a dangerous point, a satellite image when the point is identified as a change, etc.

When a plurality of dangerous points are detected in a predetermined section, the dangerous section setting unit 70 sets the section as a dangerous section. For example, when a travel route is set by an occupant of the vehicle 11 and a plurality of dangerous points are detected during a predetermined distance in the travel route, the dangerous section setting unit 70 sets the section as a dangerous section and stores information on the dangerous section in the server 12. When two or more dangerous points are detected in a predetermined section, the dangerous section setting unit 70 may set the section as a dangerous section. When five or more dangerous points are detected in a predetermined section, the dangerous section setting unit 70 may set the section as a dangerous section.

In the present embodiment, the information on the dangerous point set by the dangerous point setting unit 68 and the information on the dangerous section set by the dangerous section setting unit 70 are notified to the occupant of the vehicle 11 by the display device 58. For example, the position of the dangerous point and the dangerous section may be displayed on the traveling route displayed by the display device 58.

The vehicle position information acquisition unit 72 acquires information on the current location of the vehicle 11. Specifically, the vehicle position information acquisition unit 72 acquires the position information of the vehicle 11 positioned by GPS device 56.

The upper limit speed setting unit 74 sets an upper limit speed of the vehicle 11. Specifically, the upper limit speed setting unit 74 compares the current location of the vehicle 11 with the dangerous point, and sets an upper limit of the vehicle speed with respect to the vehicle 11 when the vehicle 11 is approaching the dangerous point. That is, the upper limit speed setting unit 74 instructs the in-vehicle device 28 to set the upper limit speed. The in-vehicle device 28 instructs a ECU (not shown) that controls the accelerator operation amount etc. to control the vehicle 11 so as not to exceed a predetermined speed. As a result, the vehicle 11 cannot travel at a speed equal to or higher than a predetermined speed until passing through the dangerous point. When it is confirmed that the vehicle 11 has passed through the dangerous point, the upper limit speed setting unit 74 cancels the setting of the upper limit speed for the in-vehicle device 28. In addition, the upper limit speed setting unit 74 similarly sets the upper limit speed of the vehicle 11 for the dangerous section.

### Effects

Next, the effect of the present embodiment will be described.

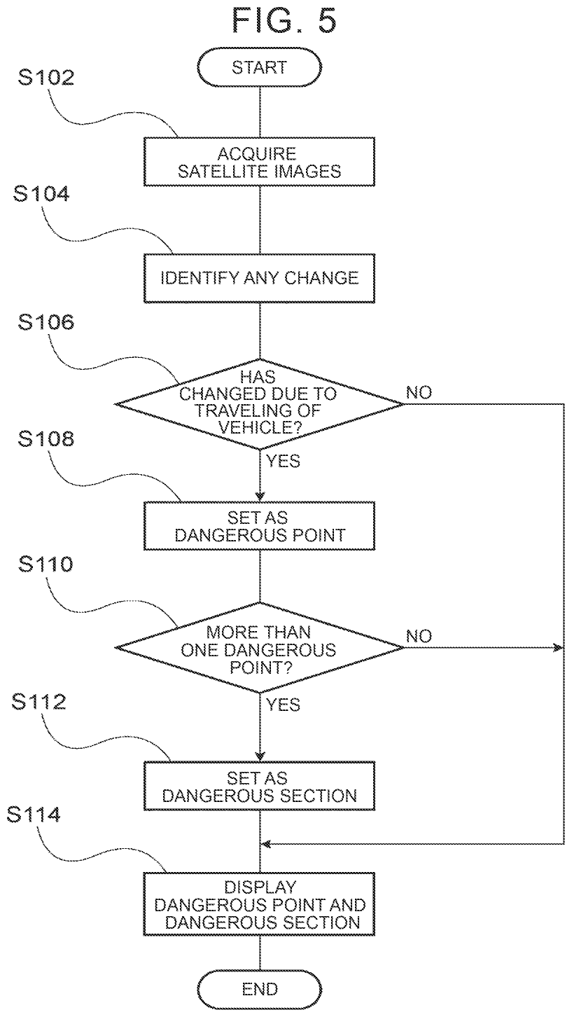

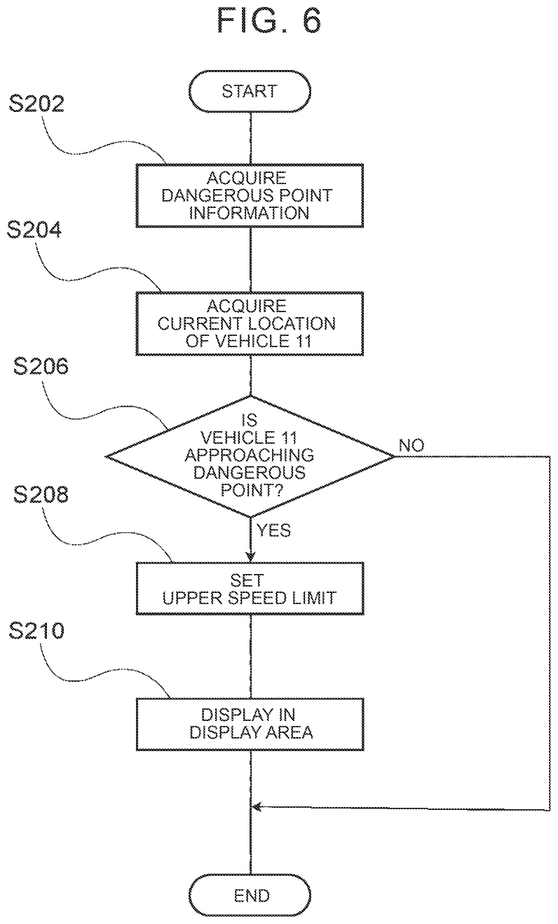

An example of information processing by the information processing device 10 of the present embodiment will be described with reference to the flowcharts shown in FIG. 5 and FIG. 6. These display processes are executed by the CPU 30 reading out the display program from ROM 32 or the storage 36, expanding the program into a RAM 34, and executing the program. In the present embodiment, as an example, the information processing is executed after the traveling route is set by the occupant of the vehicle 11.

### Example of Information Processing

The CPU 30 acquires satellite images at S102. Specifically, the CPU 30 acquires the first satellite image and the second satellite image for the area corresponding to the travel route by the function of the satellite image acquisition unit 62. For example, the CPU 30 acquires the latest satellite image as the second satellite image, and acquires the satellite image captured a predetermined time before the second satellite image was captured as the first satellite image.

The CPU 30 identifies a change in S104. Specifically, the CPU 30 identifies the change from the first satellite image and the second satellite image by the function of the change identification unit 64.

The CPU 30 determines in S106 whether the change is caused by traveling of the vehicle. Specifically, the CPU 30 determines that the change is caused by traveling of the vehicle by the function of the determination unit 66, when the change satisfies a predetermined condition. In this case, the CPU 30 proceeds to S108. When the CPU 30 determines in S106 that the change is not caused by traveling of the vehicle, the information processing is terminated.

The CPU 30 sets the change as a dangerous point in S108. Specifically, the CPU 30 sets the change as a dangerous point by the function of the dangerous point setting unit 68. At this time, the CPU 30 may notify the occupant of the vehicle 11 of the dangerous point. For example, the display device 58 may display the information on the dangerous point in the display area in the vehicle cabin to notify the occupant of the dangerous point.

The CPU 30 determines whether there are a plurality of dangerous points in a predetermined section by S110. Specifically, when there are a plurality of dangerous points in the travel route of the vehicle 11, the CPU 30 determines that there are a plurality of dangerous points and proceeds to S112 process. When there is only one dangerous point in a predetermined section in S110, the CPU 30 terminates this information processing.

The CPU 30 sets the relevant section as a dangerous section in S112. Specifically, the CPU 30 sets, as the dangerous section, a section in which a plurality of dangerous points exist by the function of the dangerous section setting unit 70.

The CPU 30 notifies the occupant of the dangerous point and the dangerous section by S114. Specifically, the CPU 30 causes the display device 58 of the vehicle 11 to display the information of the dangerous point and the information of the dangerous section in the display area. At this time, when it is determined in S110 that there is only one dangerous point (negative determination), the CPU 30 displays only the information of the dangerous point in S114. In addition, when it is determined in S106 that there is no change caused by traveling of the vehicle (negative determination), the CPU 30 does not display the information of the dangerous point and the dangerous section in S114.

### Other Examples of Information Processing

Next, a process of setting the upper limit speed of the vehicle 11 will be described with reference to FIG. 6. This process is executed, for example, at predetermined intervals while the vehicle 11 is traveling.

The CPU 30 acquires the information of the dangerous point by S202. Specifically, the CPU 30 accesses the server 12 to acquire information on a dangerous point and information on a dangerous section stored in the server 12. For example, the CPU 30 may acquire only the information of the dangerous point and the information of the dangerous section at the point corresponding to the traveling route.

The CPU 30 acquires the current location of the vehicles 11 in S204. Specifically, the CPU 30 acquires information on the current location of the vehicle 11 from the GPS device 56 by the function of the vehicle position information acquisition unit 72.

The CPU 30 determines whether or not the vehicle 11 is approaching the dangerous point or the dangerous section by S206 to a predetermined distance. Specifically, the CPU 30 compares the current location of the vehicle 11 with the coordinates of the dangerous point or the dangerous section acquired in S202, and when the distance between the vehicle 11 and the dangerous point or the dangerous section is less than the predetermined distance, it is determined that the vehicle 11 is approaching the dangerous point or the dangerous section, and the process proceeds to S208. On the other hand, when the CPU 30 determines in S206 that the vehicle 11 is not approaching the dangerous point or the dangerous section by a predetermined distance, the process ends.

The CPU 30 sets the upper limit speed in S208. Specifically, the CPU 30 instructs the in-vehicle device 28 to set the upper limit speed by the function of the upper limit speed setting unit 74.

The CPU 30 performs predetermined display in a display area in the vehicle cabin in S210. Specifically, the CPU 30 displays that the upper deceleration is set in the display area by the display device 58, that the dangerous point or the dangerous section is close, and the like. Then, the CPU 30 ends this process.

As described above, according to the information processing system S and the information processing device 10 according to the present embodiment, the second satellite image captured at the same point as the first satellite image a predetermined time after the first satellite image was acquired. The first satellite image and the second satellite image are compared with each other to identify any change in state therebetween. As described above, by comparing the satellite images and identifying any change, changes can be identified in a wide range of area without installing cameras on a road etc.

Further, it is determined whether the change is a portion where the state has changed due to traveling of the vehicle, and when the change is caused by traveling of the vehicle, the change is set as a dangerous point. Thus, even in a region where the infrastructure is not sufficiently maintained, a region where the number of vehicles traveled is small, or the like, a dangerous point can be identified. As a result, it is possible to grasp dangerous spots on the traveling road in a wide range of area.

Further, in the present embodiment, a portion where a brake mark is generated due to sudden braking of a vehicle or the like and a portion where an accessory of a road is damaged due to traveling of the vehicle are identified as a change, so that it is possible to notify the occupant of information on these points.

Furthermore, in the present embodiment, by setting a section in which a plurality of dangerous points are detected as the dangerous section, it is possible to alert an occupant of the vehicle or the like.

Further, in the present embodiment, by setting the upper limit speed for the vehicle 11 that is going to travel through the change set as the dangerous point, it is possible to suppress occurrence of an accident or the like at the dangerous point.

Although the information processing system S and the information processing device 10 according to the embodiment have been described above, it is needless to say that the present disclosure can be implemented in various forms without departing from the gist of the present disclosure. For example, in the above embodiment, when the change is a portion including a brake mark and when the change includes a portion where an accessory of the road is damaged, the determination unit 66 sets the change as a dangerous point as this change is a portion where the state has changed due to traveling of the vehicle. However, the present disclosure is not limited to this, and other changes may be included in the dangerous point. For example, when an accident of a vehicle is detected from a satellite image, the location may be included in the dangerous point.

In the above embodiment, the upper limit of the vehicle speed is set when the vehicle 11 is approaching the dangerous point or the dangerous section to a predetermined distance, but the present disclosure is not limited thereto. For example, the occupant may be alerted without setting the upper limit of the vehicle speed. Further, for example, a traveling route that does not pass through the dangerous point and the dangerous section may be searched for and proposed to the occupant.

Further, the process executed by the CPU 30 by reading the program in the above-described embodiment may be executed by various processors other than the CPU 30. Examples of the processor include a programmable logic device (PLD) in which a circuit configuration can be changed after manufacturing, such as a field-programmable gate array (FPGA), and a dedicated electric circuit that is a processor having a circuit configuration designed exclusively for performing a particular process, such as an application-specific integrated circuit (ASIC). In addition, the above processes may be executed by one of these various processors, or may be executed by a combination of two or more processors of the same kind or different kinds. For example, the processes may be executed by a plurality of FPGAs, a combination of the CPU and the FPGA, and the like. Furthermore, the hardware structure of each of the various processors is, more specifically, an electric circuit in which circuit elements such as semiconductor elements are combined.

Further, in the above embodiment, the storage 36 is configured to store various data. However, the present disclosure is not limited to this. For example, a non-transitory recording medium such as a compact disk (CD), a digital versatile disk (DVD), and a universal serial bus (USB) memory may be used as the storage unit. In this case, various programs, data, etc. are stored in these recording media.

Furthermore, the flow of the process described in the above embodiment is merely illustrative, and unnecessary steps may be omitted, new steps may be added, or the processing order may be changed without departing from the gist.

What is claimed is:

1. An information processing device configured to
acquire a first satellite image captured at a predetermined point by an artificial satellite and a second satellite image captured at the point a predetermined time after the first satellite image is captured,
compare the first satellite image and the second satellite image to identify any change in state between the first satellite image and the second satellite image,
determine whether the change is a portion where the state has changed due to traveling of a vehicle, and
when the change is the portion where the state has changed due to traveling of the vehicle, set the change as a dangerous point.

2. The information processing device according to claim 1, wherein the information processing device is configured to, when the change is a portion including a brake mark, determine that the change is the portion where the state has changed due to traveling of the vehicle.

3. The information processing device according to claim 1, wherein the information processing device is configured to, when a plurality of the dangerous points is detected within a predetermined section, set the section as a dangerous section.

4. The information processing device according to claim 1, wherein the change includes a portion where an accessory of a road is damaged.

5. An information processing system, comprising:
the information processing device according to claim 1; and
a vehicle control device configured to control the vehicle, wherein the vehicle control device is configured to set an upper limit of a vehicle speed for a vehicle traveling near the change set as the dangerous point by the information processing device.
